(19) United States
(12) Patent Application Publication
(10) Pub. No.: US 2023/0416104 A1
(43) Pub. Date: Dec. 28, 2023

(54) METHOD FOR PRODUCING COAGULANT ALUMINIUM SALTS

(71) Applicant: KEMIRA OYJ, Helsinki (FI)

(72) Inventors: Tapio HONKANEN, Espoo (FI); Forrest STRICKLAND, Atlanta, GA (US); Matias PENTTINEN, Espoo (FI); Fazlollah AZARNOUSH, Helsingborg (SE)

(21) Appl. No.: 18/036,987

(22) PCT Filed: Nov. 25, 2021
(86) PCT No.: PCT/FI2021/050806

§ 371 Date: May 15, 2023

(30) Foreign Application Priority Data
Nov. 26, 2020 (FI) 20206206

(51) Int. Cl. C01F 7/743; C01F 7/56; C01F 7/66

(52) U.S. Cl. CPC C01F 7/743; C01F 7/66; C01F 7/56

(57) ABSTRACT

The invention relates to a method for producing coagulant aluminium salts. Raw material comprising at least one aluminium oxide compound is mixed with a process acid or a base to form a reaction mixture, which is heated to a reaction temperature of at least 100° C. at a reaction pressure. The aluminium oxide compound is allowed to react with the process acid or the base. The aluminium oxide compound is selected from a group consisting of amorphous aluminium oxide, γ-aluminium oxide, η-aluminium oxide, χ-aluminium oxide, or any of their mixtures. The reaction pressure is at least 2 bar(g).

### CROSS REFERENCES

This application is a U.S. national stage application of international patent application number PCT/FI2021/050806 filed on Nov. 25, 2021, claiming priority to Finnish national application number FI20206206 filed on Nov. 26, 2020.

### FIELD OF INVENTION

The present invention relates to a method for producing coagulant aluminium salts and to a use of an aluminium oxide compound according to preambles of enclosed independent claims.

### BACKGROUND

Aluminium salts are widely used as coagulants in various water treatment processes. Coagulant aluminium salts can be utilized in both raw water purification, for example for production of drinking water, as well as waste water and sewage sludge treatment.

Coagulant aluminium salts are conventionally produced by mixing aluminium-containing raw material with an acid at an elevated temperature. The aluminium-containing raw material is allowed to react with the acid, and thereafter the reaction mixture is allowed to cool down. The acid dissolves the aluminium, thus producing an aluminium salt.

In general, aluminium compounds have properties, such as solubility, which are specific for each compound. Traditionally, raw materials for commercial production of coagulant aluminium salts are aluminium hydroxides, such as aluminium trihydrate (ATH; Al(OH)₃), which are easy to dissolve. The main drawbacks considering aluminium hydroxides are their high market price and various levels of organic impurities. The theoretical maximum for aluminium content in aluminium trihydrate is 34.5 weight-%. However, the utilizable aluminium content is usually lower because of the impurities. Removing said impurities may require additional process steps, which in turn increases energy demand and further increases costs of the process.

Other aluminium-containing compounds, such as aluminium silicate minerals, for example kaolin, have also been reported as raw materials for aluminium coagulant salts. However, these compounds leave an undissolved silicate fraction that needs to be separated from the product. A further separation step may increase the demand of chemicals and energy, as well as raise the cost of the process.

### SUMMARY OF THE INVENTION

An object of the present invention is to minimise or possibly even eliminate the disadvantages existing in the prior art.

An object of the present invention is to provide a simple and cost-effective method for producing coagulant aluminium salts. The method has an additional advantage of being compatible with the concept of circular economy.

A further object of the present invention is to use an inexpensive raw material for coagulant aluminium salt production.

These objects are attained with the invention having the characteristics presented below in the characterising parts of the independent claims. Some preferable embodiments are disclosed in the dependent claims.

The features recited in the dependent claims and the embodiments in the description are mutually freely combinable unless otherwise explicitly stated.

The exemplary embodiments presented in this text and their advantages relate by applicable parts to all aspects of the invention, both the use and the method, even though this is not always separately mentioned.

A typical method according to the present invention for producing a coagulant aluminium salt comprises
obtaining raw material comprising at least one aluminium oxide compound,
mixing the raw material comprising the at least one aluminium oxide compound with a process acid or a base to form a reaction mixture,
heating the reaction mixture to a reaction temperature of at least 100° C. at a reaction pressure,
maintaining the reaction mixture at the reaction temperature and reaction pressure for a predetermined reaction time, and allowing the aluminium oxide compound(s) to react with the process acid or the base,
cooling the reaction mixture,

wherein the at least one aluminium oxide compound is selected from a group consisting of amorphous aluminium oxide, γ-aluminium oxide, η-aluminium oxide, χ-aluminium oxide, or any of their mixtures and wherein the reaction pressure is at least 2 bar(g).

A typical use according to the present invention is the use of an aluminium oxide compound selected from a group consisting of amorphous aluminium oxide, γ-aluminium oxide, η-aluminium oxide, χ-aluminium oxide, or any of their mixtures for production of a coagulant aluminium salt.

Now it has been surprisingly found that coagulant aluminium salts can be efficiently produced from raw material comprising aluminium oxide compound(s) selected from amorphous aluminium oxide, γ-aluminium oxide, η-aluminium oxide, χ-aluminium oxide, or their mixtures, at a reaction pressure of at least 2 bar(g). Unexpectedly, the coagulant aluminium salts can be produced from these cheap raw materials, often classed as waste, while minimising or even eliminating the insoluble residues formed during the process. It was highly unforeseen that these aluminium oxide compounds, which have been traditionally considered relatively insoluble could be used as a raw material for making coagulant aluminium salts. The inventors have surprisingly found that these carefully selected aluminium oxide compounds are fully suitable for the industrial production of coagulant aluminium salts, and may partly or entirely replace the conventional aluminium hydroxide raw materials in the production process. This is highly unexpected and provides several advantages in regard of process costs and overall sustainability of the coagulant aluminium salt production.

### DETAILED DESCRIPTION OF THE INVENTION

Raw materials comprising or consisting of aluminium oxide compounds that are suitable for use in the present invention are widely available, even as a very low-cost waste material or as a side-product of an industrial process. The possibility to use as a raw material an aluminium oxide compound originating from waste material for the purposes of the present invention makes the production of aluminium coagulant salts very economically viable, as well as compatible with the concept of circular economy.

According to one preferable embodiment, the raw material comprises or consists of the aluminium oxide compound which is amorphous aluminium oxide. Raw material comprising or consisting of at least one aluminium oxide compound, preferably amorphous aluminium oxide, is often available as a by-product from an industrial aluminium oxide production process, such as a production of aluminium oxide desiccants, aluminium oxide catalysts, or aluminium oxide adsorbents. Amorphous aluminium oxide cannot always be utilized in these processes, and may be considered as a landfill waste material. Therefore, utilizing amorphous aluminium oxide in the production of coagulant aluminium salts according to the present invention is advantageous both economically and environmentally, since it supports the concept of circular economy.

According to one preferable embodiment, the raw material comprises or consists of the at least one aluminium oxide compound which is selected from γ-aluminium oxide, η-aluminium oxide, χ-aluminium oxide, or any combination thereof. It has been found that these crystal forms of aluminium oxide are especially suitable for production coagulant aluminium salts in the specific process conditions now selected. Aluminium oxide compound may be selected from aluminium oxide Al₂O₃, aluminium oxides with other aluminium-to-oxygen ratios, such as Al_{2.66}O₄, or a combination thereof.

In the present disclosure, all pressure values are given as standard atmosphere pressure, denoted as atm, or as gauge pressure, denoted as bar(g). Gauge pressure is defined as pressure zero-referenced against ambient air pressure.

In the present context the term “aluminium oxide compound” is considered to comprise compounds that comprise, preferably consists of, aluminium and oxygen, which are selected from amorphous aluminium oxide, γ-aluminium oxide, η-aluminium oxide, χ-aluminium oxide, or their mixtures. In general, the aluminium oxide compounds which are suitable for use in the present invention have a solubility of at least 95 weight-%, calculated from the original weight of the aluminium oxide compound, in an aqueous hydrochloric acid solution having acid concentration of 20 weight-%, of the total weight of the solution, at 165° C., at 4.3 bar(g). The solubility is determined as follows. The solubility of an aluminium oxide compound is determined by mixing 85.1 g of the said aluminium oxide compound and 507.3 g of hydrochloric acid (32 weight-%) with 207.6 g of water, providing an aqueous hydrochloric acid solution with a final acid concentration of 20 weight-% as 100% acid, of the total weight of the solution. The solution is heated to a reaction temperature of 165° C. at a reaction pressure of 4.3 bar(g). The solution is maintained at the reaction temperature and reaction pressure for a reaction time of 2 hours. After the reaction time of 2 hours, the solution is cooled, and any undissolved material is removed from the solution and weighed. The solubility of the aluminium oxide compound in percentage is then calculated by subtracting the weight of undissolved material from the original weight of the aluminium oxide compound, giving the weight of dissolved aluminium oxide compound, and dividing the weight of dissolved aluminium oxide compound by the original weight of the aluminium oxide compound.

According to one embodiment of the invention aluminium oxide compounds suitable for the present invention may have a solubility, determined as defined above, of at least 95 weight-%, preferably at least 97 weight-%, more preferably at least 99 weight-%, even more preferably at least 99.5 weight-%. For example, aluminium oxide compounds suitable for the present invention may have a solubility of 95-100 weight-%, preferably 97-100 weight-%, more preferably 99-100 weight-% or sometimes even 99.5-100 weight-%.

Aluminium trihydrate is excluded from the aluminium compounds suitable for this invention.

Aluminium oxide compounds selected from amorphous aluminium oxide, γ-aluminium oxide, η-aluminium oxide, χ-aluminium oxide, or their mixtures which fulfil the defined solubility requirement, are advantageous in the production process of coagulant aluminium salts due to their high aluminium content, easy availability of the material, and compatibility with the concept of circular economy.

A further advantage of the present invention is that a separate step of purifying a coagulant aluminium salt may be avoided. For an efficient process of producing coagulant aluminium salts, undissolved material needs to be removed from the reaction mixture. Having to remove the undissolved material or residuals in a separate step demands time, resources and possibly a separate reactor or a separation site. It is an advantage of the present invention that the aluminium oxide compounds have a high solubility, determined as specified above. A separate step of removing undissolved material from the reaction mixture can be avoided by using aluminium oxide compounds according to the present invention. Preferably the present process is free of purification, e.g. filtration, of the reaction mixture after formation of the desired coagulant aluminium salt.

The reaction mixture is formed by mixing the raw material comprising or consisting of at least one an aluminium oxide compound selected from amorphous aluminium oxide, γ-aluminium oxide, η-aluminium oxide, χ-aluminium oxide, or their mixtures with a process acid or a base. The reaction mixture preferably comprises or consists of the aluminium oxide compound(s) and the process acid or the base in water, i.e. the reaction mixture is an aqueous mixture. Concentration of the process acid or the base in the reaction mixture may be at least 5 weight-%, preferably at least 10-weight-%, more preferably at least 15 weight-% of the total weight of the reaction mixture. In an embodiment, concentration of the process acid or the base in the reaction mixture may be in a range of 5-60 weight-%, preferably in the range of 10-50-weight-%, more preferably in the range of 20-40 weight-%, given as 100% acid or base, of the total weight of the reaction mixture.

According to one preferable embodiment, the reaction mixture may be formed by mixing the raw material comprising an aluminium oxide compound with a process acid. In the present method various, preferably inorganic, acids may be used as the process acid. The used process acid may preferably be a strong inorganic acid. According to one preferable embodiment, the process acid may be selected from hydrogen chloride (HCl), sulfuric acid (H₂SO₄), nitric acid (HNO₃), or any combination thereof. By way of example, aluminium chloride may be produced by selecting hydrogen chloride as the process acid; aluminium sulfate may be produced by selecting sulfuric acid as the process acid; and aluminium nitrate may be produced by selecting nitric acid as the process acid. Other suitable acids may be used to produce other aluminium salts.

When the reaction mixture is formed by mixing the raw material comprising an aluminium oxide compound with a process acid, the reaction mixture preferably has a pH, which is 2 or lower than 2, preferably 1 or lower than 1. For example, the pH may be in a range from 0-2, preferably 0-1.

In another embodiment, the reaction mixture may be formed by mixing the raw material comprising at least one aluminium oxide compound with a base. Preferably, the base is a strong base. The base may be selected, for example, from sodium hydroxide (NaOH), potassium hydroxide (KOH), lithium hydroxide (LiOH), or any combination thereof. By way of example, sodium aluminate (NaAlO₂) may be produced by selecting sodium hydroxide as the base; potassium aluminate (KAlO₂) may be produced by selecting potassium hydroxide as the base; and lithium aluminate (LiAlO₂) may be produced by selecting lithium hydroxide as the base.

When the reaction mixture is formed by mixing the raw material comprising at least one aluminium oxide compound with a base, the reaction mixture preferably has a pH which is 10 or higher than 10, preferably 12 or higher than 12. For example, the pH may be in a range from 10-14, preferably 12-14.

Advantageously, the reaction mixture may have an aluminium concentration of at least 1 weight-%, preferably at least 3 weight-%, more preferably at least 4.5 weight-%, of the total weight of the reaction mixture. For example, the reaction mixture may have the aluminium concentration in the range of 1-10 weight-%, preferably in the range of 3-8 weight-%, more preferably in the range of 4.5-7 weight-% in the reaction mixture, of the total weight of the reaction mixture. Use of the relatively high aluminium concentrations disclosed herein decreases the need of water in the reaction mixture, which in turn decreases the amount of waste water that needs to be treated in a separate step and saves the fresh water required by the process.

The reaction mixture is heated to a reaction temperature of at least 100° C. According to one preferable embodiment, the reaction mixture may be heated to the reaction temperature of at least 120° C., preferably at least 140° C., more preferably at least 150° C. For example, the reaction mixture may be heated to the reaction temperature in a range of 100-250° C., preferably in the range of 130-180° C., more preferably in the range of 150-170° C.

The reaction pressure is at least 2 bar(g). This means that the method is performed in a pressurized reactor, where the aluminium oxide compound is allowed to react with the process acid or the base at a reaction pressure of at least 2 bar(g), preferably at least 2.3 bar(g), more preferably at least 2.5 bar(g), sometimes even at least 4 bar(g). The reaction pressure may be at most 5 bar(g), preferably at most 4.8 bar(g), more preferably at most 4.5 bar(g). In certain embodiments, the reaction pressure may be in the range of 2-5 bar(g), preferably in the range of 2.3-4.8 bar(g), more preferably in the range of 2.5-4.5 bar(g).

Efficiency of the reaction between the aluminium oxide compound and the process acid or the base may be enhanced by carefully selecting the used reaction temperature, reaction pressure, and reaction time. By increasing the reaction temperature and pressure, the reaction time may be decreased, and vice versa. An optimal combination of the reaction conditions may result in an efficient coagulant aluminium salt production process in terms of material usage, energy demand and production cost. The present invention thus provides a process that can be tailored to suit the selected raw material.

The reaction mixture is maintained at the selected reaction temperature and at the selected reaction pressure for a predetermined reaction time, which allows the aluminium oxide compound to react with the acid or the base in the reaction mixture for production of the desired aluminium salt. In an embodiment, the reaction time may be selected from a range of 0.5-5 hours, preferably 1-4 hours, more preferably 1-2 hours.

After the required reaction time at the predetermined reaction temperature and pressure, the reaction mixture, which is in form of an aqueous solution, is cooled to a temperature lower than the reaction temperature, preferably lower than 100° C.

The resulting coagulant aluminium salt may be obtained in an ionic form in solution or as a solid compound.

According to one embodiment of the invention the raw material comprising at least one aluminium oxide compound may comprise at the maximum 5 weight-% of trace metals, organic impurities and/or the like. Preferably, the raw material comprising at least one aluminium oxide compound may comprise less than 1 weight-% trace metals, organic impurities and/or the like. When the raw material comprises low amounts of trace metals, organic impurities and/or the like, it is possible to minimise the amount of insolubles in the process and/or ensure the purity of the produced coagulant aluminium salts.

Aluminium content for aluminium oxide compounds suitable for the present invention may be at least 35 weight-%, preferably at least 40 weight-%, more preferably at least 42 weight-%. For example, the aluminium content for aluminium oxide compounds suitable for the present invention may be 35-55 weight-%, preferably 40-50 weight-%, more preferably 42-50 weight-%. For example, the theoretical maximum for aluminium content in aluminium oxide (Al₂O₃) is 52.9 weight-%. Due to a small amount of impurities, the actual measured values for the aluminium content in aluminium oxide compounds may be slightly lower than the theoretical maximum. Because of the high aluminium content, it is more economically viable to use aluminium oxide compounds instead of other aluminium-containing raw materials to produce coagulant aluminium salts.

According to an embodiment of the invention, the amount of undissolved material after the reaction of the aluminium oxide compound with the process acid or the base is less than 5 weight-%, preferably less than 3 weight-%, more preferably less than 1 weight-%, even more preferably less than 0.5 weight-% of the original weight of the raw material comprising at least one aluminium oxide compound. In an embodiment, the amount of undissolved material after the reaction is 0-5 weight-%, preferably 0-3 weight %, more preferably 0-1 weight-%, even more preferably 0-0.5 weight-% of the original weight of the raw material comprising at least one aluminium oxide compound.

According to one embodiment, the raw material comprising at least one aluminium oxide may be obtained by heat treatment. The heat-treatment produces aluminium oxide compounds that are suitable for the present invention. The aluminium oxide compounds obtained through heat-treatment may appear in several different crystal forms suitable for the present invention. For example, the heat treatment may produce aluminium oxide in crystal forms selected from γ-aluminium oxide, η-aluminium oxide, χ-aluminium oxide, or any combination thereof. According to one embodiment, raw material comprising at least one aluminium oxide compound suitable for the present invention may originate from aluminium-containing material that have been heat-treated at a temperature lower than 750° C., preferably lower than 450° C., more preferably lower than 300° C. In an embodiment, the raw material comprising at least one aluminium oxide compound may originate from an aluminium-containing material heat-treated at a temperature in the range of 200-750° C., preferably in the range of 200-500° C., more preferably in the range of 220-300° C.

It is possible to use several naturally available sources as the aluminium-containing material that may be heat-treated. For example, aluminium-containing materials suitable for use as a raw material in the present invention after heat treatment may originate from a natural mineral selected from gibbsite, bayerite, boehmite, diaspore, or any combination thereof.

In certain embodiments, aluminium-containing materials suitable for use in the present invention may originate from a natural mineral selected from gibbsite, bayerite, boehmite, diaspore, or any combination thereof, even without heat treatment, provided that the aluminium oxide compound in the natural mineral is in the form specified in the present invention.

In the method according to the present invention, conventional process equipment and techniques may be used. The conventional process equipment may comprise agitators and/or mixers, reaction vessels and/or reaction tanks, pressurizers, raw material supply equipment, heaters, and any other equipment conventionally used in a process of producing coagulant aluminium salts. By carefully selecting the reaction conditions, such as reaction temperature, reaction pressure, and reaction time, the process may be optimized for coagulant aluminium salt production that is efficient in terms of time, material usage, energy demand and production cost.

### EXAMPLES

Some embodiments of the invention are described in the following non-limiting examples.

### Example 1 (Reference)

40.0 g of amorphous aluminium oxide Al₂O₃ was mixed with 265.9 g hydrochloric acid (37 weight-%). The reaction was carried out at 100° C. and at atmospheric pressure for 4.0 hours. Aluminium chloride AlCl₃ solution was produced. 3.5 weight-% undissolved material was left after the reaction.

### Example 2 (Reference)

40.0 g of aluminium oxide compound comprising amorphous Al₂O₃, boehmite, and bayerite was mixed with 265.9 g hydrochloric acid (37 weight-%). The reaction was carried out at 102° C. and at atmospheric pressure for 4.0 hours. Aluminium chloride AlCl₃ solution was produced. 3.75 weight-% undissolved material was left after the reaction.

### Example 3

85.1 g of amorphous aluminium oxide Al₂O₃ was mixed with 507.3 g hydrochloric acid (32 weight-%) and 207.6 g water. The reaction was carried out at 165° C. and at 4.3 bar(g) for 2 hours. 800 g of aluminium chloride AlCl₃ solution was produced. Aluminium concentration of the AlCl₃ solution was 5 weight-%. A non-measurable amount of undissolved material was left after the reaction.

### Example 4

102.4 g of amorphous aluminium oxide Al₂O₃ was mixed with 278.2 g sulfuric acid (96 weight-%) and 319.7 g water. The reaction was carried out at 155° C. and at 2.9 bar(g) for 1.0 hours. 700 g of aluminium sulfate Al₂(SO₄)₃ solution was produced. Aluminium concentration of the Al(SO₄)₃ solution was 6.25 weight-%. A non-measurable amount of undissolved material was left after the reaction.

### Example 5

75.5 g of aluminium oxide compound comprising amorphous Al₂O₃, boehmite, and bayerite was mixed with 507.3 g hydrochloric acid (32 weight-%) and 217.2 g water. The reaction was carried out at 165° C. and at 4.3 bar(g) for 1.45 hours. 800 g of aluminium chloride AlCl₃ solution was produced. Aluminium concentration of the AlCl₃ solution was 4.94 weight-%. A non-measurable amount of undissolved material was left after the reaction.

### Example 6

92.5 g of aluminium oxide compound comprising amorphous Al₂O₃, boehmite, and bayerite was mixed with 278.2 g sulfuric acid (96 weight-%) and 329.4 g water. The reaction was carried out at 155° C. and at 2.9 bar(g) for 1.0 hours. 700 g of aluminium sulfate Al₂(SO₄)₃ solution was produced. Aluminium concentration of the Al(SO₄)₃ solution was 6.12 weight-%. A non-measurable amount of undissolved material was left after the reaction.

### Example 7

75.5 g of η-aluminium oxide Al_{2.66}O₄ was mixed with 507.0 g hydrochloric acid (32 weight-%) and 217.5 g water. The reaction was carried out at 165° C. and at 4.5 bar(g) for 2 hours. 800 g of aluminium chloride AlCl₃ solution was produced. Aluminium concentration of the AlCl₃ solution was 4.8 weight-%. A non-measurable amount of undissolved material was left after the reaction.

### Example 8

96.3 g of η-aluminium oxide Al_{2.66}O₄ was mixed with 278.2 g sulfuric acid (96 weight-%) and 325.5 g water. The reaction was carried out at 155° C. and 2.9 bar(g) for 1.0 hours. 700 g of aluminium sulfate Al₂(SO₄)₃ solution was produced. Aluminium concentration of the Al(SO₄)₃ solution was 6.78 weight-%. A non-measurable amount of undissolved material was left after the reaction.

### Example 9

105.3 g of amorphous aluminium oxide Al₂O₃ was mixed with 281 g sulfuric acid (96 weight %) and 163.7 g water. The reaction was carried out at 155° C. and at 2.9 bar(g) for 1.0 hours. 550 g of solid aluminium sulfate Al₂(SO₄)₃*17 H₂O was produced. Aluminium concentration of the Al(SO₄)₃ solution was 9.0 weight-%. A non-measurable amount of undissolved raw material was left after the reaction.

It can be seen that when the process is conducted at atmospheric pressure, undissolved residuals exist after the reaction, even after a prolonged reaction time (Reference examples 1 and 2). In practice, these residuals must be removed by filtration, which complicates the process when performed in industrial scale. It is seen from examples 3-9 that when the process is performed under pressure and by using the specific aluminium oxide compounds as raw material, non-measurable amounts of residuals exist after the reaction. Furthermore, the reaction time can be significantly reduced, which improves the productivity and efficiency of the process.

1. A method for producing a coagulant aluminium salt, the method comprising
obtaining raw material comprising at least one aluminium oxide compound,
mixing the raw material comprising the at least one aluminium oxide compound with a process acid or a base to form a reaction mixture,
heating the reaction mixture to a reaction temperature of at least 100° C. at a reaction pressure,
maintaining the reaction mixture at the reaction temperature and reaction pressure for a reaction time, and allowing the at least one aluminium oxide compound to react with the process acid or the base, and
cooling the reaction mixture,
wherein the at least one aluminium oxide compound is selected from a group consisting of amorphous aluminium oxide, γ-aluminium oxide, η-aluminium oxide, χ-aluminium oxide, and any of their mixtures and wherein the reaction pressure is at least 2 bar(g).

2. The method according to claim 1, wherein the raw material comprising the at least one aluminium oxide compound is mixed with a process acid, wherein the reaction mixture has a pH, which is preferably lower than 2, more preferably lower than 1.

3. The method according to claim 1, wherein the process acid is selected from hydrogen chloride (HCl), sulfuric acid (H₂SO₄), nitric acid (HNO₃), or a combination thereof.

4. The method according to claim 1, wherein the raw material comprising the at least one aluminium oxide compound is mixed with a base selected from sodium hydroxide (NaOH), potassium hydroxide (KOH), lithium hydroxide (LiOH), or any combination thereof, wherein the reaction mixture preferably has a pH higher than 10, more preferably higher than 12.

5. The method according to claim 1, wherein the reaction mixture has an aluminium concentration of at least 1 weight-%, preferably at least 3 weight-%, more preferably at least 4.5 weight-%, of the total weight of the reaction mixture.

6. The method according to claim 1, wherein the reaction mixture is heated to the reaction temperature of at least 120° C., preferably at least 140° C., more preferably at least 150° C.

7. The method according to claim 1, wherein the reaction pressure is at least 2.3 bar(g), preferably at least 2.5 bar(g).

8. The method according to claim 7, wherein the reaction pressure is in a range of 2-5 bar(g), preferably 2.3-4.8 bar(g), more preferably 2.5-4.5 bar(g).

9. The method according to claim 1, wherein the reaction time is in a range of 0.5-5 hours, preferably 1-4 hours, more preferably 1-2 hours.

10. The method according to claim 1, wherein the amount of undissolved material after the reaction of the aluminium oxide compound with the process acid or the base is less than 5 weight-%, preferably less than 3 weight-%, more preferably less than 1 weight-%, even more preferably less than 0.5 weight-%.

11. The method according to claim 1, wherein the raw material comprising the at least one aluminium oxide compound originates from an aluminium-containing material heat-treated at a temperature lower than 750° C., preferably lower than 450° C., more preferably lower than 300° C.

12. The method according to claim 11, wherein the aluminium-containing material originates from a mineral selected from gibbsite, bayerite, boehmite, diaspore, or any combination thereof.

13. The method according to claim 1, wherein the raw material comprising the at least one aluminium oxide compound is a by-product from an industrial aluminium oxide production process, such as a production of aluminium oxide desiccant, aluminium oxide catalyst, or aluminium oxide adsorbent.

14. (canceled)
